(19) United States
(12) Patent Application Publication
(10) Pub. No.: US 2005/0036193 A1
(43) Pub. Date: Feb. 17, 2005

(54) Interferometric system for selection of optical beam spectral components

(75) Inventors: Yves Defosse, Plougonvelin (FR); Michel Barge, Milizac (FR); Jean-Louis De Bougrenet De La Tocnaye, Guilers (FR); Denis Battarel, Plougonvelin (FR); Nicole Wolffer, Plouzane (FR)

Correspondence Address: MERCHANT & GOULD PC, P.O. BOX 2903, MINNEAPOLIS, MN, 55402-0903, US

(73) Assignees: GET-ENST BRETAGNE, Brest (FR); OPTOGONE, Plouzane (FR)

(21) Appl. No.: 10/893,678

(22) Filed: Jul. 16, 2004

(30) Foreign Application Priority Data
Jul. 30, 2003 (FR) FR 03 09412

(51) Int. Cl. G01J 1/00; G02F 1/01

(52) U.S. Cl. 359/279

(57) ABSTRACT

The invention relates to an interferometric system (2) for selection of spectral components of an incident optical beam as a function of their wavelength, comprising:
means (42) of transforming the said incident optical beam into two spatially demultiplexed beams;
means (43) of shifting the phase of at least one of the said spatially demultiplexed beams, the phase shift being applied spatially so as to produce two so-called phase shifted beams, the phase of at least one of their components being shifted as a function of its wavelength;
means (44, 42) of recombining the said phase shifted beams adapted to produce a first and a second output beam, each of the said output beams being multiplexed in wavelength and comprising components of the said phase shifted beams, selected as a function of a first and a second phase shift respectively.

This invention relates to the domain of optics, and more precisely to the selection of optical beam spectral components, enabling treatment of the optical beam as a function of the wavelengths or particular spectral bands.

Selection of the wavelengths or spectral bands enables a wide variety of applications, particularly in the field of optical telecommunications (particularly at high speeds), for example gain or channel equalisation (or attenuation) of spectrum or spectral bands, extraction and/or insertion of wavelengths (OADM), switching and optical routing. It also can be used for applications in the field of spectroscopy.

### STATE OF THE ART

Different optical techniques using free space have been proposed to make a selection of spectral components of an optical beam. According to the state of the art, a dynamic spectrum equaliser uses an optical demultiplexer that transforms the spectral multiplex into a spatial multiplex. Each wavelength is thus separated and then imaged on a programmable element (for example a spatial light modulator (SLM) placed in an imagery plane of the input plane.

According to the state of the art, this programmable element may have different functions, and particularly:
attenuation of the optical beam (as proposed in patent document EP1207418 deposited on behalf of the ALCATEL® company and entitled “dynamic spatial equaliser based on a spatial light modulator” using a PDLC (Polymer Dispersed Liquid Crystal) type liquid crystal;
a modification of its complex amplitude (diffractive or holographic element); or
a deviation so as to modify the coupling function in the input fibre.

This deviation technique involves different approaches:
by diffractive elements (as described in patent documents WO 01/11419 by the LIGHTCONNECT® Company or WO 98/06192 by the University of Cambridge);
by phase modification (as shown in patent documents WO 03/009054 and WO 02/071133 by the XTELLUS® Company entitled “gain equaliser for optical fibre” and “optical attenuator for fibre) respectively; or
by beam deviation (as indicated in patent document US 6204946 by the LUCENT TECHNOLOGIES® Company.

The purpose of all these techniques is to deteriorate the coupling balance and thus to selectively act on the spectrum of wavelengths, the optical fibre in this case acting as a spatial filter.

Another approach to the state of the art uses the interferometric principle (for example a Mach-Zehnder interferometer), the spectral treatment being obtained by cascading interferometers tuned on a fixed wavelength, for example using a Bragg grating, and acting as the corresponding number of spectral filters (as mentioned in patent documents US 2003/0035616 (“add-drop multiplexer with a signal amplification capacity), U.S. Pat. No. 6,424,763 (“add-drop filter using a resonating tunnel with coupling on the side”) by MIT® and JP2001109022 (“add-drop optical multiplexer with a switching function”) by the NTT® Company.

Wavelength selection or attenuation is obtained by different techniques such as the introduction of a variable delay on one of the two arms of the interferometer (for example as shown in patent document EP0783127 entitled “Mach-Zehnder interferometric coupler with monomode optical fibre).

These different techniques have the disadvantage that they use Bragg gratings centred on fixed wavelengths. Therefore they do not enable continuous selection of bands or wavelengths.

Furthermore, these techniques have the disadvantage of cascading losses, which causes severe losses, particularly when the guide is long.

Furthermore these techniques make it possible to process a relatively small number of channels.

### PRESENTATION OF THE INVENTION

The invention and its various aspects are intended particularly to overcome these disadvantages according to prior art.

More precisely, one purpose of the invention is to supply a compact and robust system for selection of spectral components of an optical beam.

Another purpose of the invention is to provide an optical selection system that is relatively simple to implement and is easily reconfigurable.

Another purpose of the invention is to enable optical selection of spectral components that is easy to control reliably.

Another purpose of the invention is to enable a selection that enables fast variation of the selected wavelength(s) and is particularly well adapted to high-speed telecommunication applications (in particular routing, equalisation, and switching).

These objectives and others which will be referred to later are achieved by the invention using an interferometric system for selection of spectral components of an incident optical beam as a function of their wavelength, the system comprising:
means of transforming an incident optical beam into two spatially demultiplexed beams;
means of shifting the phase of at least one of the spatially demultiplexed beams, the phase shift being applied spatially so as to produce two so-called phase shifted beams, the phase of at least one of their components being shifted as a function of its wavelength;
means of recombining phase shifted beams adapted to produce a first and a second output beam, each output beam being multiplexed in wavelength and comprising components of phase shifted beams, selected as a function of a first and a second phase shift respectively.

Thus, as a function of phase shifts specific to each of the wavelengths (or spectral bands) of the phase shifted beams, the first and second output beam each comprise all or part of the spectral components of the input signal, in a complementary manner. Therefore, the system can select one or several spectral components, some of these components possibly being equalised (for example the case in which one of the output beams is considered, the attenuation being a function of the phase shift applied to the phase shifted beams), blocked (the attenuation being maximum for the wavelength considered), switched towards one of the output fibres, etc.

According to one particular characteristic, the system is remarkable in that the first phase shift is equal to approximately zero modulo 2π radians, the components of the phase shifted beams being approximately in phase, and in that the second phase shift is approximately equal to π modulo 2π radians, the components of the phase shifted beams being approximately in phase opposition.

Thus, it is relatively simple to block a wavelength or a spectral band, or to route it with minimized optical losses.

According to one particular characteristic, the system is remarkable in that the means of transforming the incident optical beam comprise means for imagery and spatial demultiplexing of at least one optical beam and splitting means.

According to the invention, the splitting means act either on the incident beam or on spatially demultiplexed beams.

According to one particular characteristic, the system is remarkable in that the imagery and spatial demultiplexing means are placed on the optical path between the splitting means and the phase shifting means.

According to one particular characteristic, the system is remarkable in that the splitting means are placed on the optical path between the imagery and spatial demultiplexing means and phase shifting means.

According to one particular characteristic, the system is remarkable in that the imagery means are adapted to propagation of an optical signal in free space.

According to one particular characteristic, the system is remarkable in that the imagery means comprise at least one first lens with a first focal length and a second lens with a second focal length, and in that:
the first lens is located at the first focal length from the input of the imagery means;
the second lens is placed at the second focal length from the output of the imagery means; and
the first and second lenses are separated by a distance corresponding to the sum of the first and second focal lengths.

This embodiment is compatible with many applications, and in particular enables introduction of any optical element (for example demultiplexer, filter, etc.) on the optical path particularly in the Fourier plane of the first and second lenses (plane at a distance equal to a multiple of the corresponding focal lengths of the lenses).

According to one particular characteristic, the system is remarkable in that the spatial demultiplexing means are located in a Fourier plane of the first and second lenses.

According to one particular characteristic, the system is remarkable in that the means of transforming the incident optical beam comprise a demultiplexer guided in planar optics, adapted to demultiplexing of at least one optical beam, and splitting means.

Thus, the system is particularly robust.

According to one particular characteristic, the system is remarkable in that the phase shifting means are placed in an imagery plane of the imagery means so as to enable a phase shift as a function of each spatially multiplexed component.

According to one particular characteristic, the system is remarkable in that the phase shifting means include programmable phase shifting means.

In this way, it is possible to control the phase shift as a function of determined wavelengths or spectral bands.

According to one particular characteristic, the system is remarkable in that the programmable phase shifting means are adapted to delay an optical beam in a variable manner and belong to the group comprising:
deformable mirrors
micro-mirrors; and
optical materials enabling modulation of the refraction index.

In particular, the phase shifting means can be made easily in the form of a strip. The optical materials may or may not be isotropic, and may for example be nano-PDLC associated with controllable electrodes.

According to one particular characteristic, the system is remarkable in that the phase shifting means include non-programmable phase shifting means.

In particular, these phases shifting means may be added to compensate an optical path. For example, they may be delay lines made in free space or from a fibre.

According to one particular characteristic, the system is remarkable in that the phase shifting means are associated with at least one mirror.

Thus, the system is particularly easy to implement, at least part of the transformation means being common with the combination means, the splitting means being used to recombine two beams by reverse return.

According to one particular characteristic, the system is remarkable in that the spatial demultiplexing means belong to the group comprising:
prisms
holographic gratings; and
blazed gratings.

According to one particular characteristic, the system is remarkable in that the splitting means comprise a splitter.

Thus, the splitting means are used in the form of a separating blade or a separating cube.

According to one particular characteristic, the system is remarkable in that the splitting means comprise a coupler.

According to one particular characteristic, the system is remarkable in that the recombination means and the transformation means have at least one part in common.

In particular, this simplifies the system and reduces the manufacturing cost.

According to one particular characteristic, the system is remarkable in that it includes means within the group comprising:
optical equalisation means;
wavelength blockers;
spectral band selectors; and
optical routing means.

Thus, the invention is particularly well adapted to communication links or networks, particularly at high speeds.

According to one particular characteristic, the system is remarkable in that it includes means of measuring the optical spectrum of the incident optical beam.

The system thus enables a very wide variety of applications, particularly in the field of spectroscopy or even telecommunications (for “monitoring” optical beams).

According to one particular characteristic, the system is remarkable in that it forms a monolithic component.

In particular, this makes it compact and very simple to use.

According to one particular characteristic, the system is remarkable in that the transformation means and the phase shifting means are separate.

Thus, the system can easily be configured as a function of the different applications.

### LIST OF FIGURES

Other characteristics and advantages of the invention will become more obvious after reading the following description of a preferred embodiment given as an illustrative and non-limitative example, and the attached drawings among which:
FIGS. 1a to 1c diagrammatically show an optical equaliser according to the embodiments conforming with the invention;
FIG. 2 shows a multiplexer/demultiplexer imager block used in the equaliser in FIGS. 1a to 1c;
FIGS. 3a to 3c describe an interferometric block (or DRI) used in the equaliser in FIG. 1a;
FIGS. 4a and 4c illustrate phasing shift elements used in the equaliser in FIGS. 1a to 1c;
FIGS. 5a, 5b, 6a and 6b have variant embodiments of the equaliser according to the invention;
FIGS. 7a to 7d describe a DRI used in the equaliser in FIGS. 1b and 1c; and
FIG. 8 shows an equaliser principle based on a DRI as shown with reference to FIG. 3c.

### DETAILED DESCRIPTION OF THE INVENTION

The invention is based on a solution using free space or being extended to planar optics. The invention enables attenuation and/or selection of wavelengths or spectral bands based on the interferometric division—recombination (DRI) principle, applied independently and in parallel on wavelengths output from the WDM signal, unlike the state of the art in which the same result is obtained by cascading the interferometers which is more complex to implement.

More precisely, according to the invention, the interferometric part is materialised by a block for splitting—recombination of two beams (DRI) (the fibre coupler or the beam splitter). The intensity can be modulated almost continuously by varying constructive or destructive interferences (free space) or by coupling modes (case of the guide), and in particular, very good extinctions on the selected wavelength or spectral band can be obtained during phase opposition. Therefore, this system is compatible with existing specifications for making dynamic selectors of spectral bands or wavelength blockers requiring rejections exceeding 35 dB (corresponding to optical amplifiers in terms of noise; part of the optical signal, attenuated or blocked by a DSE (Dynamic Spectral Equaliser) should not be amplified again by passing through optical amplifiers.

The invention proposes an equalisation system comprising three independent optical blocks:
a multiplexer/demultiplexer imager block 42;
a phase shifting element 43 associated with a mirror 44 ; and
an interferometric block 41 (DRI) arranged either at the input to the imager block 42 according to FIG. 1a, or inserted between the imager block 42 and the phase shifting element 43 according to FIGS. 1b and 1c.

More precisely, FIGS. 1a, 1b and 1c respectively illustrate equalisation systems 2, 4 and 5 accepting an optical signal transmitted by an optical fibre 1 as input and outputting a signal on an optical fibre 3. The fibres 1 and 3 may or may not comprise collimation means depending on the different variants of the invention.

According to FIG. 1a, the input signal is firstly separated by the DRI 41 of the equalisation system 2, into two independent and coherent optical beams that act as input to the block 42. The imager block 42 spatially demultiplexes these two independent optical beams as a function of their spectral components to be laterally imaged on the phase shifting element 43 before being reflected by the mirror 44. The reflected optical beams then pass through the imager block 42 that recombines them spatially as a function of their phase shifts (using an interferometric principle, phase shifting on one of the interferometer arms cancelling the output energy):
to the output fibre 1 (for components of the two beams, in phase (the phase shift Δφ being zero modulo 2π)); and/or
to the input fibre 3 (for the components of the two beams, in phase opposition (the phase shift Δφ being equal to π modulo 2π)).

According to FIGS. 1b and 1c, the input signal is spatially demultiplexed by the imager block 42 that creates an image of the demultiplexed beam on the phase shifting element 43). The demultiplexed beam passes through the DRI 41 that transforms it into two independent optical beams (each being associated with an image on the phase shifting element 43). The phase shifted beams are then reflected by the mirror 44. Depending on their corresponding phase shifts, the beams are then recombined to fibre 2 and/or to fibre 3.

More precisely, the phase shifted beams are recombined as a function of the phase shift value:
to the input fibre 1 through the block 42 (for components of the two beams that are in phase (the phase shift Δφ being null modulo 2π)); and/or
to the output fibre 3 (for the components of the two beams in phase opposition (the phase shift Δφ being equal to π modulo 2π)) through a multiplexer imager block 45 similar to block 42 (case shown with reference to FIG. 1b) or through a return mirror 51 (attached to the DRI 41 with an angle of 45° to form a DRI 50) to the imager block 42 (case shown with reference to FIG. 1c, in which the difference between the input and output beams separates the input fibre 1 and the output fibre 3 that are slightly offset). The equalisation system 5 is advantageous in that it uses one less imager block than the equalisation system 4.

FIG. 2 diagrammatically shows the imager block 42 making the spatial demultiplexing of a WDM signal output from the optical fibre 1, and its operating principle.

The imager block 42 shown is an imagery system in free space of the 4f type that comprises the following elements in sequence along its optical axis that is parallel to the direction of propagation of the incident beam:
a first lens 421;
a dispersive element 422, for example of the prism or blazed grating type, holographic grating or any element making a dispersion of the incident beam;
a second lens 423.

According to one variant, the lens 421 is integrated into an input/output fibre.

The imager block 42 shown is an imagery system in free space of the 4f type, where f represents the focal length of the lenses 421 and 422 with the dispersive element 422 placed in the filter plane of the assembly. The lens 421 is placed at a distance f from the input 420 (to which the fibre 1 is attached) and from the dispersive element 422. Therefore, the input signal converges on the imager block 42.

The lens 423 is also placed at a distance f from the dispersive element 422. Moreover, the equalisation systems 3 and 4 are such that there is an optical distance f between the lens 423 and the mirror 44 so as to produce a real image of the signal before it passes through the dispersive element 422, on the mirror 44. As shown symbolically in FIG. 2, the dispersive element separates the different components each associated with a wavelength λI (spatial demultiplexing illustrated in the dispersion plane), and an image of the signal with the different components of the signal appears on the mirror 44.

According to one variant of the invention, the lenses 421 and 423 have different focal lengths, equal to f1 and f2 respectively. The lens 421 is then placed at a distance f1 from the input 420 and the dispersive element 422. The lens 423 is placed at a distance f2 from the dispersive element 422. The equalisation systems 3 and 4 are also such that there is an optical distance f2 separating the lens 423 and the mirror 44.

According to another variant of the invention, the imager block is of the AWG (Array Wave Guide) type. An AWG type imager block corresponds to a combination of phasars (delay lines in the form of wave guides) with distinct lengths. Due to the different lengths of the phasars, the block includes an intermediate region that is the Fourier plane between inputs/outputs with an intermediate matrix of active modulators that equalises the channels. It is a planar optical solution with a higher cost per channel than a solution in free space. Insertion losses, PDLs (Polarisation Dispersion Losses) and PDM (Polarisation Dispersion Mode) losses are also higher.

The interferometric block DRI 41 comprises at least one element separating the incident optical beam into two independent beams, and recombining them either to one input or to an output by inverse return as a function of the delay generated between the two beams in the spatial modulator block through the demultiplexer imager block. The spatial modulator optionally includes a variable element that can be controlled either to delay or shift the phase of the optical paths between the two arms, and a mirror.

FIGS. 3a to 3c show different variant embodiments of the DRI 41 according to the invention used in a configuration of the optical equaliser as shown with reference to FIG. 1a. Two options could be used to make the DRI block: in free space (FIGS. 3a and 3b) and guided (fibre or plane guide, according to the example in FIG. 3c).

According to one embodiment shown with reference to FIG. 3a, a DRI 41 is used. An incident optical beam penetrates into the DRI 41 through an input 410 associated with the fibre 1, as far as a splitter 411 that splits it equitably into two beams. One of these beams is reflected by a mirror 414 at 45° or a prism with total reflection so as to arrange two parallel beams at the input to the imager block 42.

According to one variant of the invention, these beams are collimated, for example using a collimation optics coupled to fibre 1.

The two beams pass through the imager/demultiplexer block 42. The spectral components of one of the beams (according to a Michelson type configuration) or of the two beams (according to a Mach-Zehnder type configuration) are imaged laterally on the phase shifters 43 and therefore phase shifted by the phase shifters 43. The two beams are then reflected by the mirror 44, pass through the imager/multiplexer system 42 and then along an inverse path, and recombine on the splitter 411 of the DRI 41. Depending on the nature of the phase shift between the two beams, a recombination is obtained on fibre 1 if the phase shift is zero and on fibre 3 if the phase shift is equal to π (which is used particularly for wavelength blocker, spectral band selector or optical routing type applications). If the phase shift is equal to other modulo 2π values, the recombination is made on the two fibres 1 and 3 at a proportion that depends on the phase shift (so that the incident beam can be equalised).

FIG. 3b shows a DRI 416 comprising a splitter 4165 and two prisms 4166 and 4167 with total reflection. An incident beam 4162 output from the fibre 1 is firstly separated into two beams by the splitter 4165. Each beam is then reflected several times onto one of the prisms 4166 or 4167. Thus, in this set up, a fibre emulates two secondary virtual sources 4161 and 4162 that produce two parallel output beams 4163 and 4164. After processing by the imager 42, the phase shifter 43 and the mirror 44, similar to that described with reference to FIG. 3a, the DRI accepts two beams in reverse return, in which the phases of the spectral components are shifted. The splitter 4165 then combines the two beams on fibre 1 and/or on fibre 3 depending on the value of the phase shift associated with each spectral component.

According to another variant embodiment of the DRI shown with reference to FIG. 3c and used in the configuration of the equaliser 2 described with reference to FIG. 1a, the optical beam is separated by means of 3 dB coupler 415 (coupling by evanescent mode or by merging guides or fibres). The signal is injected into the coupler 415 through an input 4150 associated with the fibre 1 and is then guided by a guide 4151 as far as a coupling area 4153 with length Lc (where 4Lc is the coupling period). The signal is thus distributed equitably between two inputs/outputs 4154 and 4155; therefore each of the outputs 4154 and 4155 recovers about 50% of the incident signal. The beams are then imaged and demultiplexed by the imager block 42 and are then phase shifted by the phase shifter(s) 43 in the same way as was described for FIG. 3a. After reflection and multiplexing, the two output beams penetrate into the coupler 415 through inputs/outputs 4154 and 4155. As above, depending on the nature of the phase shift between the two beams, recombination on the fibre 1 takes place if the phase shift is zero and on fibre 3 (associated with an output 4152) if the phase shift is equal to π.

Taking account of the demultiplexing device 420 used, each wavelength λi is imaged laterally on an independent phase shifting element and is reflected as indicated in FIGS. 4a and 4b.

A programmable element is placed on at least one of the two interferometer arms and can be used either to delay (shift the phase) or to extend optical paths as required on the corresponding arm(s) so as to modify interference formation conditions between two beams output from the interferometric block and to select outputs.

According to the invention, the two outputs from the DRI block 41 imaged in the plane of the phase shifter (SLM (Spatial Light Modulator) corresponding to a sequence of independent phase shifters forming a strip comprising several pixels), are modulated independently by means of a variable delay. This variable delay is obtained according to the invention particularly by extending the optical path (for example using an SLM comprising MEMS type deformable micro-mirrors to cause a delay in the optical path) or by a modulation of the index (for example using liquid crystal or nano-PDLC in the SLM) on one or both of the two arms.

FIG. 4a shows the case in which the index is modulated on a single arm. According to this embodiment, a first incident beam 430 is imaged on the phase shifter 43 comprising a strip SLM enabling variable delays. The beam 430 comprises different components associated with distinct spatially separated wavelengths λi. Each of these components passes through a strip element (pixel) of the phase shifter 43, assigning a particular value to this component specific to the pixel concerned on the strip. Thus, the delay affecting components of the beam 430 depends on the state of the pixel in the strip through which this component passes, and therefore on the spatially multiplexed wavelength. The phase shifted incident beam is reflected by the mirror 44 and once again passes through the phase shifter to produce a reflected signal 431 comprising spatially multiplexed components for which each of the wavelengths is assigned a phase shift that depends on this wavelength.

A second incident beam 432 is simply reflected by the mirror 44 and no phase shift dependent on this wavelength is applied to it.

FIG. 4b shows the case in which an index modulation is made on two arms. In this case, two incident beams 435 and 437 are imaged on phase shifters 433 and 435 respectively, similar to the phase shifter 43 before being reflected by a mirror 439 and passing once again through the phase shifters 433 and 435. Thus, each of the wavelengths of the output beams 436 and 438 is assigned a phase shift that depends on this wavelength.

According to one embodiment with two phase shifted beams, the difference compared with a conventional interferometer lies in the materialisation of an intermediate interference plane (Fourier plane) made possible by a 4f imagery system in free space, enabling the introduction of a dispersive element acting in common and independently on the two beams (arms) and the result of which is to make the interferometer spectrally parallel, this operation being difficult to obtain with a conventional interferometer. The relative delay between the two beams (each associated with one arm) is introduced in the imagery plane of the 4f assembly, in which these two beams are separated and dispersed as a function of the wavelength (according to the embodiments shown with reference to FIG. 4b) and in which a mirror is placed that returns the two beams to the input of the optical system, recombining them spectrally (by inverse return) and by energy at the splitter or the coupler, with routing to one of the two interferometer output channels depending on their corresponding phase shifts (as indicated with reference to FIGS. 2 and 3a to 3c).

FIG. 5a shows the system 41 presented with reference to FIG. 1a and its elements shown with reference to FIGS. 2, 3a (or 3b, 3c) and 4b, and including a parallelised image set up. The system 41 has the advantage that only one multiplexer/demultiplexer imager 42 is necessary. Moreover, it requires two adjacent (or almost adjacent) strips 433, 434 on the same substrate (in other words with a common electronic part) and being separated by a few tens of microns (the length of the strips 433, 434 being of the order of 1 mm).

According to one variant shown with reference to FIG. 5b, the equalisation system comprises a DRI 5 and two parallel arms 50 and 51 each comprising a 4f type imagery imager block in free space (a dispersive block (502, 512) being placed in the focal plane of the two lenses (pairs 501, 503 and 511, 514) and a phase shifting element (504 and 514 respectively) adjacent to a mirror (505 and 515 respectively).

If it is only a mirror and provided that the optical paths are equivalent, the two beams reformed in the output plane are in phase and the entire energy is recombined in the input fibre (except for system insertion losses).

On the other hand, if the phase of one of the two beams is shifted with respect to the other in the imagery plane, a delay is generated at the recombination and a different energy distribution is observed on the two output arms of the interferometer, that depends on this phase shift.

According to one variant of the invention that is relatively easy to use, the equalisation system uses a conventional demultiplexer (particularly for the first arm) provided with an element that can independently delay each of the spectrum wavelengths and recombine them. The second arm of the interferometer is composed of a delay line that emulates an equivalent path on the non-demultiplexed spectrum (shown with reference to FIG. 4a, there is no need to do demultiplexing on the two arms).

FIG. 6a shows this type of embodiment and more precisely an equalizer comprising a DRI associated with an input fibre 1, an output fibre 3 and with two inputs/outputs separating an input signal on the two arms 50 and 60 and recombining the signal returned by these two arms 50 and 60. Elements similar to elements in the previous figures are marked with the same references and therefore are not described further. The arm 60 is a 4f imagery system comprising two lenses 601 and 603 with focal length f and a mirror 605. The first lens 601 is placed at a distance f from the corresponding output of the DRI 5; the two lenses 601 and 603 are separated by a distance 2f, and the mirror 605 is placed at a distance f from the lens 603. Thus, the optical signal passes through a distance equal to 1f in the two arms 50 and 60.

According to one variant, the two lenses 601 and 603 have different focal lengths f1 and f2 respectively. The first lens 601 is placed at a distance f1 from the corresponding output of the DRI 5; the two lenses 601 and 603 are separated by a distance equal to the sum of the focal lengths f1 and f2 and the mirror 605 is placed at a distance f2 from the lens 603. Thus, the optical signal passes through a distance 2×(f1+f2) in the arms 50 and 60.

According to one embodiment shown with reference to FIG. 6b, the first arm 60 is replaced by an arm 61 comprising a segment with an equivalent optical length, namely 4f , and that therefore performs the same optical delay function equivalent to arm 50.

In other words, the arms 60 and 61 create optical paths with length equivalent to the length of arm 50.

According to one variant, the equaliser arm, comprising the delay line (particularly arm 60 or 61) is provided with an additional variable attenuator, thus enabling balancing of power at the coupler to maximise the rejection rate.

According to another variant, the equaliser arm, comprising the delay line (particularly arm 60 or 61) is provided with a compensating splitter to correct the unbalance in the arm lengths that could degrade transmission of very high-speed signals.

FIGS. 7a to 7c illustrate a system 4 in which the interferometric block 41 is inserted between the phase shifting element 43 and the imager/demultiplexer system 42 as shown with reference to FIGS. 1b and 1c.

Obviously, the DRI 41 is used in a similar manner:
in an architecture in which it is inserted between an imager/demultiplexer (case of FIGS. 1b and 1c) and the phase shifting element 43, the DRI 41 acts on an optical beam demultiplexed spatially into wavelengths and returns a demultiplexed optical beam either to the input imager/demultiplexer system 42 (FIG. bb) or to a second output imager/demultiplexer system (FIG. 1c); and
in an architecture in which it is located between the system input and the imager, the DRI 41 acts on an optical beam that is not spatially multiplexed and the imager processes two input beams and output beams (FIG. 1a).

Only the nature of the beams processed by the DRI is associated with the architecture of the optical system.

According to this variant, the interferometric block 41 acts directly on the demultiplexed signals, just before passing through the strip(s) of the variable phase shifter 43. This block is easy to make. For example it may be a splitter (semi-transparent) and in practice for practical reasons a separating cube placed in contact with the spatial modulator(s) according to the principle shown in FIG. 7a. Thus, this solution has the advantage that it can directly integrate the interferometric block at the phase shifting element, and therefore limit sources of mechanical and thermal disturbances of the interferometric part.

As shown with reference to FIG. 7b, a part of the beam illuminates the modulator 43 in reflection, while the other part is reflected by the back mirror 71 of the semi-transparent splitter.

According to variants shown with reference to FIGS. 7c and 7d, the back mirror 71 is replaced by a second modulator (72 and 75 respectively associated with a mirror 73 and 74) which enables better balancing of the arms (intensity and phase, compensating for any defects in the modulator). Recombination is done according to the inverse return principle, either along the axis of incidence of the chromatic spectrum or perpendicular to it.

According to the variant in FIG. 7c, the phase shifters 72 and 43 are identical and isotropic (for example, they may be variable delay devices of the MEMS or nano-PDLC) type.

On the other hand, according to the variant in FIG. 7d, the phase shifters 75 and 43 are identical and anisotropic with their specific axes oriented perpendicular to each other (along directions 77 and 76 respectively). Each of the polarisation components is modulated independently by one or the other of the phase shifters so as to create the same phase shift on recombination between the two arms of the interferometer. For example the phase shifters 75 and 43 are obtained by means of a nematic liquid crystal combed along the two orthogonal directions 77 and 76.

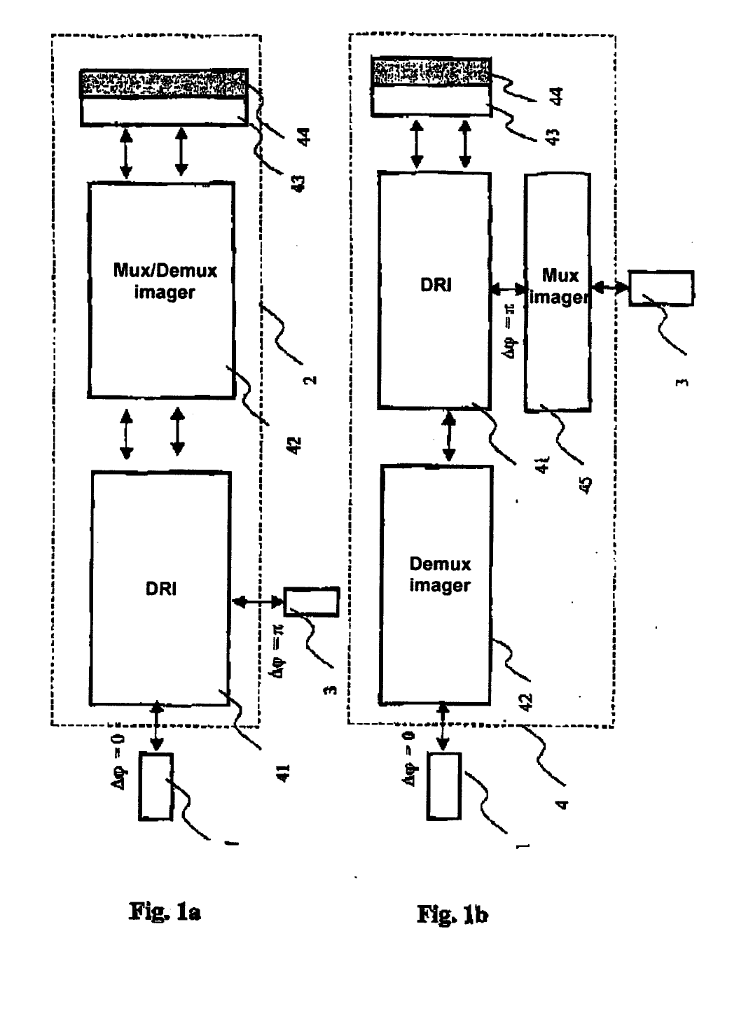

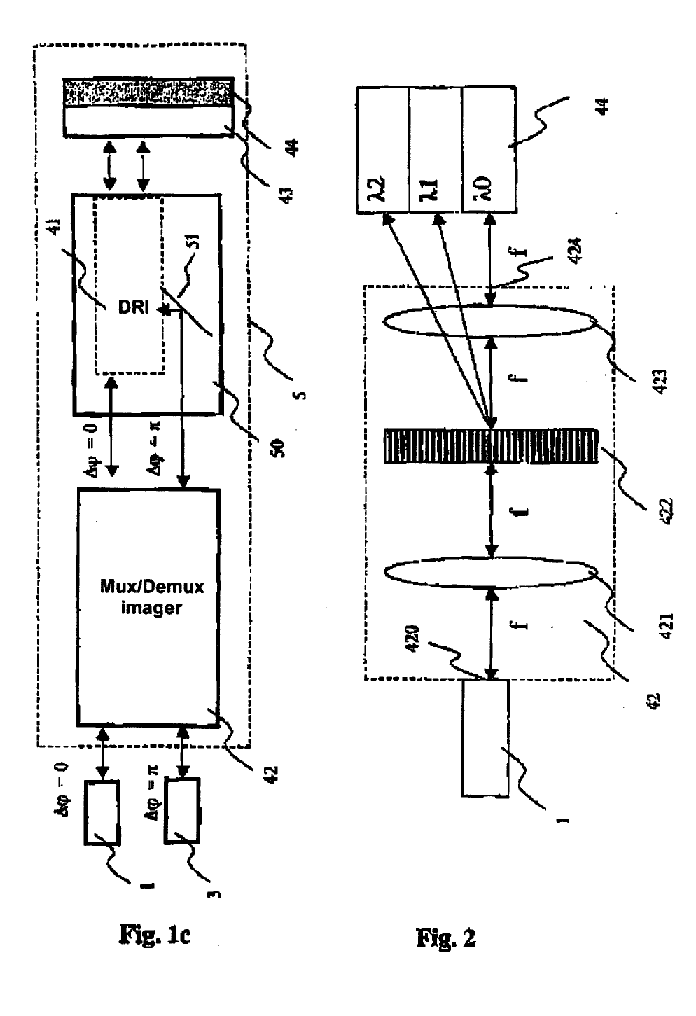

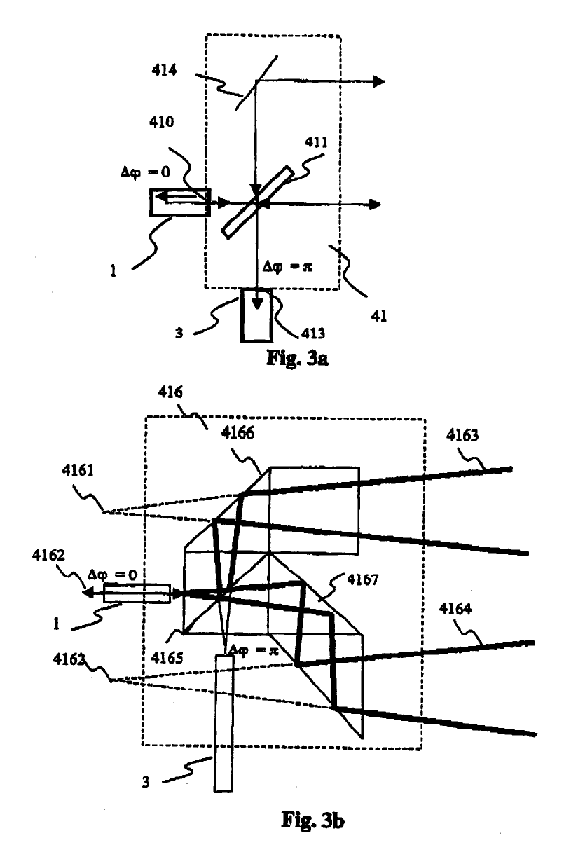

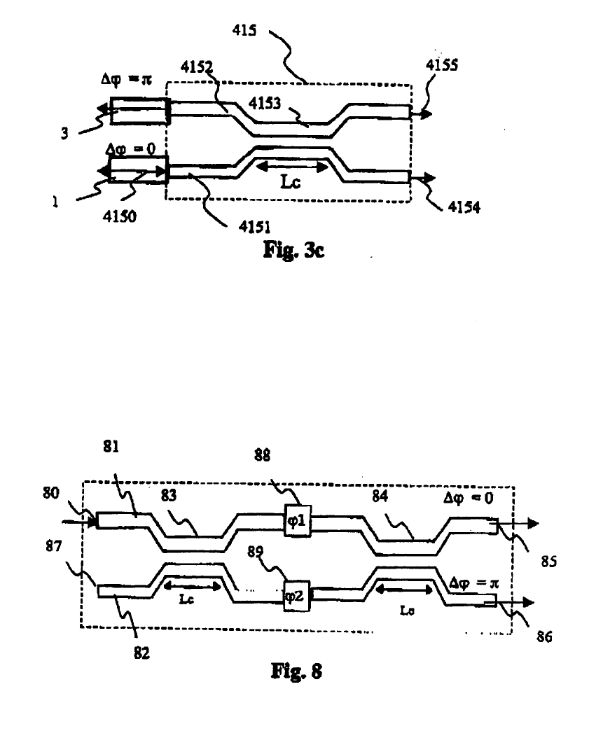

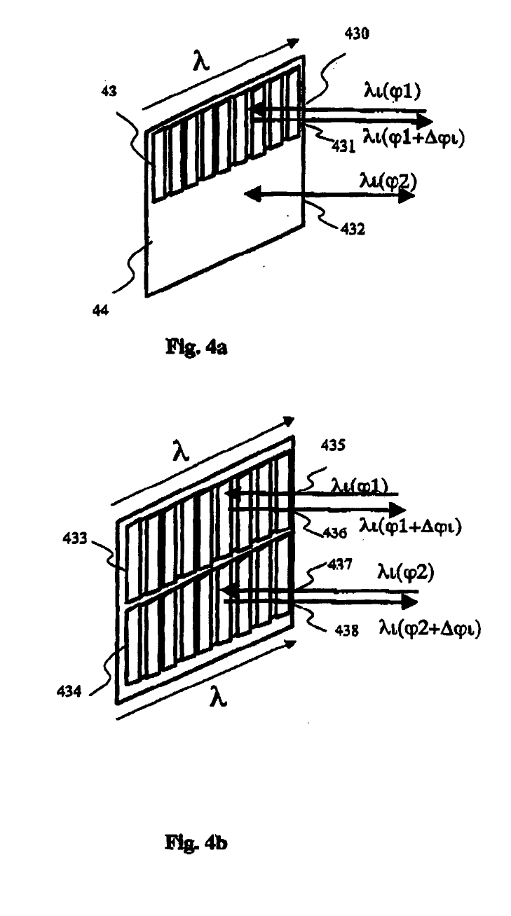

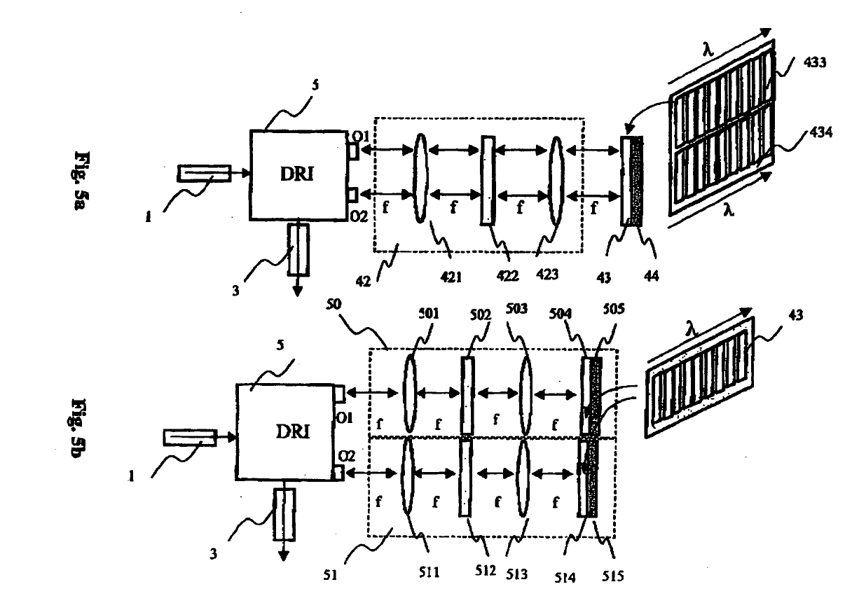

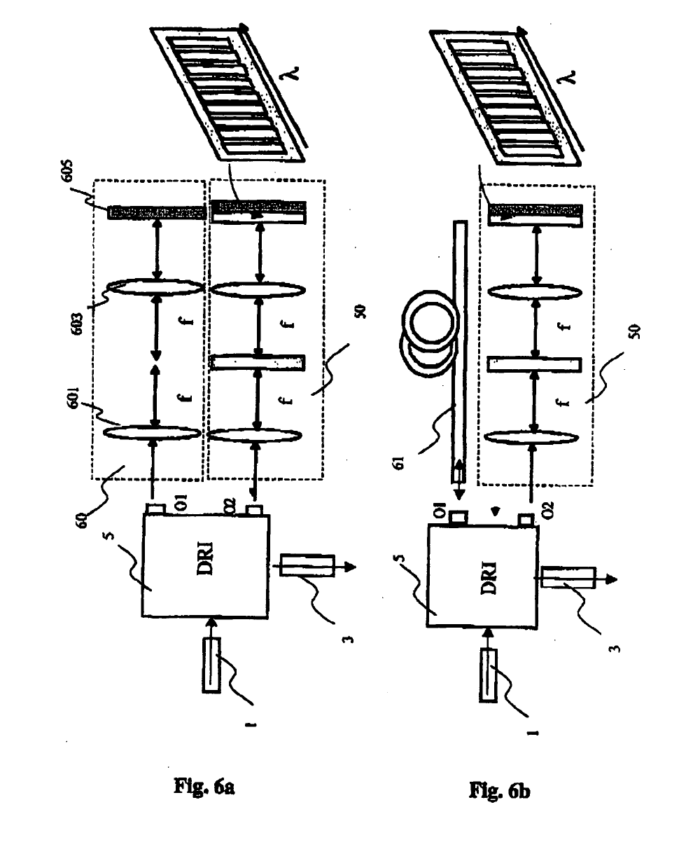

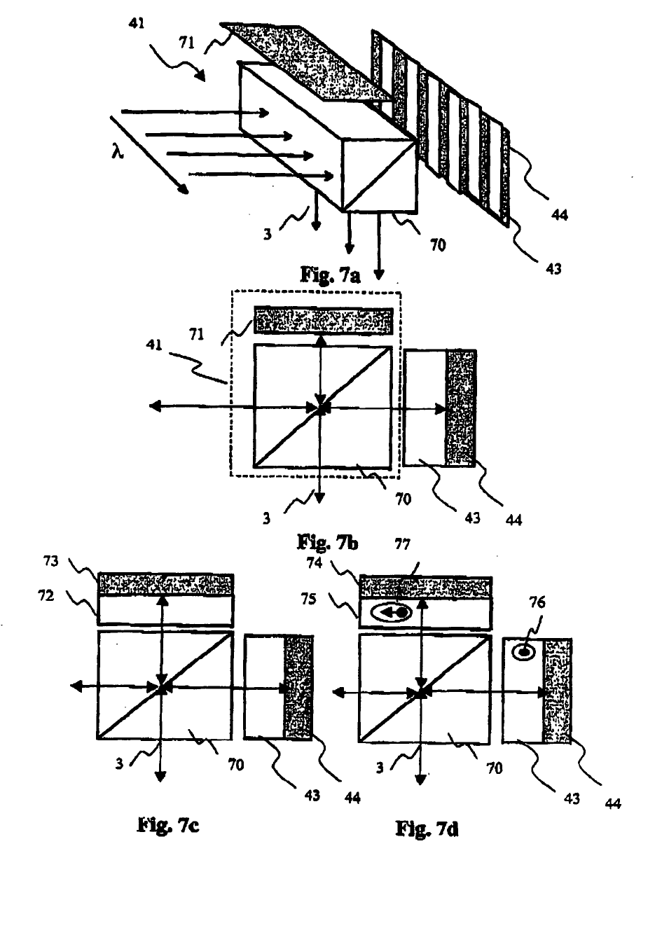

FIG. 8 diagrammatically shows the interferometric principle when a fibre or guide coupler type DRI is used such as the coupler 414 presented with reference to FIG. 3c used in a set up like that shown in FIG. 1a (the imagery and mirror means are not shown). The Mach-Zehnder type configuration includes two couplers 81 and 82 similar to the coupler 415 presented with reference to FIG. 3c. The first coupler 81 is used to distribute the intensity in the two arms (generally 50% in each of the arms 81 and 82). The signal is injected on one of the input channels 80 and 87. A mechanical or electro-optical element 88 and 89 (corresponding to the phase shifters 43) then modifies the phase between the two guides (in this case, the programmable elements located in the imagery plane) in each of the arms separating the couplers 81 and 82. Finally, the second coupler 82 is used to recover and combine the signal in one of the two guides 85 or 86, or output fibres.

Depending on the phase shift Δφ between the arms 81 and 82, an output corresponding to one of the inputs/outputs is activated and the intensity function I1 and I2 is given on each channel 85 and 86 respectively by the relations:
I₁=I₀ sin² Δφ/2 (output 86); and
I₂=I₀ cos² Δφ/2 (output 85); (where Δφ represents the phase difference φ1-100 2 between the signals penetrating into the coupler 84);

where I₀ represents the intensity of the incident signal (optical losses being neglected).

Thus, if one of the channels has to be identified as the output channel and the second as the input channel of the device used as is the case here in a set up in reflection, an isolator must be added on the input channel to eliminate the power that could be recoupled in it. This type of solution has the advantage of materialising a DCE input and output (compared with more frequently used embodiments in which the input fibre acts as the output fibre), or to replace a circulator by an isolator.

Embodiments based on a coupler have the advantage of being compact, robust and easy to use. On the other hand, resources at phase shifting must be sufficient to balance optical paths on the output side (for example imagery plane) or a compensation element needs to be introduced on one of the two arms to balance the coupler arms.

Obviously, the invention is not limited to the example embodiments given above.

In particular, those skilled in the art could add any variant to the geometry and embodiments of the DRIs, phase shifters and demultiplexer imager blocks.

In particular, according to the invention, DRIs are used in the form of any system that makes splitting and recombination by inverse return (the DRI splitter is used by the retropropagated beam as a recombiner), and is associated with a multiplexer/demultiplexer.

The optical system according to the invention may be used in a monolithic or modular form. The modular structure, for example comprising three blocks (DRI, imager and phase shifter) enables the user to use several technologies. It also enables a simple adaptation to the required characteristics (particularly an adaptation to the number of channels, the resolution, the pass-band). The cost of the monolithic structure is usually lower and it is more robust.

The invention has many applications, in particular corresponding to applications using any technique enabling variable rejection of spectral bands along the width of the band and in attenuation, or a selection of spectral bands (particularly spectral band routing). Thus, some of the main applications of the invention are:
blocking of wavelengths or spectral bands and reconfigurable OADMs (enabling extraction and/or insertion of wavelength), particularly for use by optical communication devices;
selectable wavelength or wavelength band filters, used particularly in the spectroscopy field.

1. Interferometric system (2, 4, 5) for selection of spectral components of an incident optical beam as a function of their wavelengths, wherein the system comprises:
means (42) of transforming the said incident optical beam into two spatially demultiplexed beams;
means (43) of shifting the phase of at least one of the said spatially demultiplexed beams, the said phase shift being applied spatially so as to produce two so-called phase shifted beams, the phase of at least one of their components being shifted as a function of its wavelength;
means (44, 42) of recombining the said phase shifted beams adapted to produce a first and a second output beam, each of the said output beams being multiplexed in wavelength and comprising components of the said phase shifted beams, selected as a function of a first and a second phase shift respectively.

2. System according to claim 1, wherein the first phase shift is equal to approximately zero modulo 2π radians, the components of the said phase shifted beams being approximately in phase and in that the second phase shift is approximately equal to π modulo 2π radians, the components of the said phase shifted beams being approximately in phase opposition.

3. System according to claim 1, wherein the said transformation means of the said incident optical beam include imagery and spatial demultiplexing means (42) of at least one optical beam and splitting means (41).

4. System (2) according to claim 3, wherein the said imagery and spatial demultiplexing means are located on the optical path between the said splitting means and the said phase shifting means.

5. System (4, 5) according to claim 3, wherein the said splitting means are located on the optical path between the said imagery and spatial demultiplexing means and the said phase shifting means.

6. System according to claim 3, wherein the said imagery means are adapted to propagation of an optical signal in free space.

7. System according to claim 6, wherein the said imagery means include at least a first lens (421) with a first focal length and a second lens (422) with a second focal length, and in that:
the first lens is located at the first focal length from the input of the imagery means;
the second lens is placed at the second focal length from the output of the imagery means; and
the first and second lenses are separated by a distance corresponding to the sum of the first and second focal lengths.

8. System according to claim 7, wherein the said spatial demultiplexing means (422) are located in the Fourier plane of the first and second lenses.

9. System according to claim 1, wherein the said means of transforming the incident optical beam comprise a demultiplexer guided in planar optics, adapted to demultiplexing of at least one optical beam, and splitting means (415).

10. System according to claim 3, wherein the said phase shifting means are located in an imagery plane of the said imagery means so as to enable a phase shift as a function of each spatially multiplexed components.

11. System according to claim 10, wherein the said phase shifting means include programmable phase shifting means (43, 433, 434).

12. System according to claim 10, wherein the said programmable phase shifting means are adapted to delay an optical beam in a variable manner and belong to the group comprising:
deformable mirrors;
micro-mirrors; and
optical materials enabling modulation of the refraction index.

13. System according to claim 11, wherein the said phase shifting means include non-programmable phase shifting means (60, 61).

14. System as claimed in claim 10, wherein the said phase shifting means are associated with at least one mirror (44).

15. System as claimed in claim 3, wherein the said spatial demultiplexing means belong to the group comprising:
prisms
holographic gratings; and
blazed gratings.

16. System as claimed in claim 3, wherein the said splitting means include a splitter (411, 4165).

17. System as claimed in claim 3, wherein the splitting means include a coupler (415).

18. System as claimed in claim 1, wherein the said recombination means and the said transformation means have at least one part (411, 4165) in common.

19. System as claimed in claim 1, wherein it includes means within the group comprising:
optical equalisation means;
wavelength blockers;
spectral band selectors; and
optical routing means.

20. System as claimed in claim 1, wherein it includes means of measuring the optical spectrum of the incident optical beam.

21. System as claimed in claim 1, wherein it forms a monolithic component.

22. System as claimed in claim 1, wherein the transformation means and the phase shifting means are separate.
